(19) United States
(12) Patent Application Publication
(10) Pub. No.: US 2009/0324762 A1
(43) Pub. Date: Dec. 31, 2009

(54) MOLD CLAMPING DEVICE

(76) Inventors: Kouji Moritani, Kanagawa (JP); Yosuke Tokui, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 12/310,327

(22) PCT Filed: Nov. 6, 2007
(86) PCT No.: PCT/JP2007/071544

§ 371 Date: Feb. 20, 2009

(30) Foreign Application Priority Data
Nov. 7, 2006 (JP) 2006-301592

(51) Int. Cl. B29C 33/20

(52) U.S. Cl. 425/3

(57) ABSTRACT

A mold clamping device uses an electromagnet to generate clamping force. In the mold clamping device, a coil holding member holds a coil which constitutes a part of the electromagnet. A coil placement part is arranged in a surface of the coil holding member to place the coil therein, wherein the coil is embedded in the coil placement part by a molding material. The mold clamping device is able to cool the coil of the electromagnet appropriately.

### BACKGROUND OF THE INVENTION

1. Field of the Invention

This invention relates to a mold clamping device.

2. Description of the Related Art

Conventionally, in an injection molding machine, resin is injected from a discharge nozzle of an injection apparatus and the resin is filled in a cavity space between a fixed mold and a movable mold and solidified so that a molding product is obtained. And a mold clamping device is arranged therein for performing any of mold closing, mold clamping, and mold opening by moving the movable mold relative to the fixed mold.

Mold clamping devices may be classified into a hydraulically actuated mold clamping device and an electrically actuated mold clamping device. The former mold clamping device is actuated by supplying oil to an oil hydraulic cylinder. The latter mold clamping device is actuated or driven by an electric motor. The more widespread type is the electrically actuated mold clamping device since its controllability is high, its environmental influence is low, and its energy efficiency is high. In a case of the electrical type mold clamping device, a ball screw is rotated to generate a thrust force by driving an electric motor, and the thrust force is enlarged using a toggle mechanism so that a large clamping force is obtained.

However, since the electrical type mold clamping device uses the toggle mechanism, it is difficult for the mold clamping device of this type to change the clamping force due to the characteristic of the toggle mechanism. Since its response and stability are not excellent, controlling a clamping force during a molding process is impossible.

To avoid the problem, a conventional mold clamping device which is adapted to use a thrust force, generated by rotation of the ball screw, directly as the clamping force is proposed. In this case, the electric motor torque and the clamping force are proportional, and this enables controlling of the clamping force during a molding process.

However, in the conventional mold clamping device, the load resistance of the ball screw is low and it is difficult to generate a large clamping force. Moreover, the clamping force is fluctuated due to the torque ripple occurring in the electric motor.

In order to generate a clamping force, it is necessary to supply continuously the current to the electric motor, and this will raise the power consumption and the heating value of the electric motor. For this reason, it is necessary to enlarge the rated power of the electric motor, which causes the cost of the mold clamping device to increase.

To obviate the problem, a mold clamping device which uses a linear motor when performing a mold opening/closing operation and uses an attraction force of an electromagnet when performing a mold clamping operation has been proposed. See Patent Document 1 below.

### Patent Document 1: Published PCT International Application WO 2005/090052

### SUMMARY OF THE INVENTION

### Problem to be Solved by the Invention

However, as shown in FIGS. 8 and 9 of patent Document 1, the mold clamping device is arranged so that the electromagnet 49 is formed by winding the coil 48 around the core 46. When current is supplied to the coil 48 to generate clamping force, the heat produced in the coil must be radiated from the mold clamping device to the atmospheric air whose thermal conductivity is not high, in order to cool the coil. Thus, the mold clamping device of Patent Document 1 has the problem that the cooling efficiency is significantly low.

Moreover, the coil of the electromagnet in the mold clamping device generates heat if current is supplied thereto. If a large amount of current is supplied to the coil in order to obtain a desired clamping force, burning or damaging of the coil may take place. On the other hand, in order to prevent damaging of the coil, it is necessary to decrease the amount of the current supplied. There is the problem that decreasing the amount of the current supplied causes the properties of the electromagnet to deteriorate.

In view of the above-mentioned problems, according to one aspect of the invention, there is disclosed a mold clamping device which is able to cool the coil of the electromagnet appropriately.

### Means for Solving the Problem

In order to achieve the above-mentioned aspect, the invention provides a mold clamping device which uses an electromagnet to generate clamping force, the mold clamping device comprising: a coil holding member holding a coil which constitutes a part of the electromagnet; and a coil placement part arranged in a surface of the coil holding member to place the coil therein, wherein the coil is embedded in the coil placement part by a molding material.

The above-mentioned mold clamping device may be configured so that the molding material is placed under and does not project from the surface of the coil holding member.

The above-mentioned mold clamping device may be configured so that the coil placement part is arranged so that at least one of side faces of the coil holding member perpendicular to the surface of the coil holding member is opened.

The above-mentioned mold clamping device may be configured so that the coil placement part is arranged so that all of side faces of the coil holding member perpendicular to the surface of the coil holding member are closed.

The above-mentioned mold clamping device may be configured so that the coil placement part is arranged so that the coil placement part has a top-end portion on the surface of the coil holding member and a bottom-end portion in a depth direction of the coil placement part and a width of the bottom-end portion is larger than a width of the top-end portion.

The above-mentioned mold clamping device may be configured so that the coil placement part includes grooves on internal side faces perpendicular to the depth direction of the coil placement part.

The above-mentioned mold clamping device may be configured so that internal side faces perpendicular to the depth direction of the coil placement part are tapered so that a width of the coil placement part gradually increases in the depth direction.

### EFFECTS OF THE INVENTION

According to the invention, it is possible to provide a mold clamping device which can cool the coil of the electromagnet appropriately.

### BRIEF DESCRIPTION OF THE DRAWINGS

FIG. 1 is a diagram showing the condition of a mold device and a mold clamping device in an embodiment of the invention at the time of mold closing.

FIG. 2 is a diagram showing the condition of the mold device and the mold clamping device in the embodiment of the invention at the time of mold opening.

FIG. 3 is a diagram showing the condition of a coil placement part in a first embodiment of the invention when resin molding is performed.

FIG. 4 is a perspective view of a rear platen in a second embodiment of the invention for explaining the configuration.

FIG. 5 is a perspective view of a rear platen in which auxiliary members are arranged at opening parts of a coil placement part for explaining the configuration.

FIG. 6 is a perspective view of a rear platen in which a coil is embedded in the rear platen by a molding material.

FIG. 7 is a perspective view of a rear platen in a third embodiment of the invention in which a coil is embedded in the rear platen by a molding material.

FIG. 8A and FIG. 8B are diagrams showing the configurations of rear platens for explaining the cross-sectional configuration of each coil placement part.

### DETAILED DESCRIPTION OF THE PREFERRED EMBODIMENTS

A description will now be given of embodiments of the invention with reference to the accompanying drawings.

Suppose that, in the mold clamping device according to the invention, the direction of moving a movable platen when performing a mold closing operation is a front-end direction of the mold clamping device, and the direction of moving the movable platen when performing a mold opening operation is a rear-end direction of the mold clamping device. Moreover, suppose that, in an injection apparatus, the direction of moving a screw when performing injection is a front-end direction of the injection apparatus, and the direction of moving the screw when performing measurement is a rear-end direction of the injection apparatus.

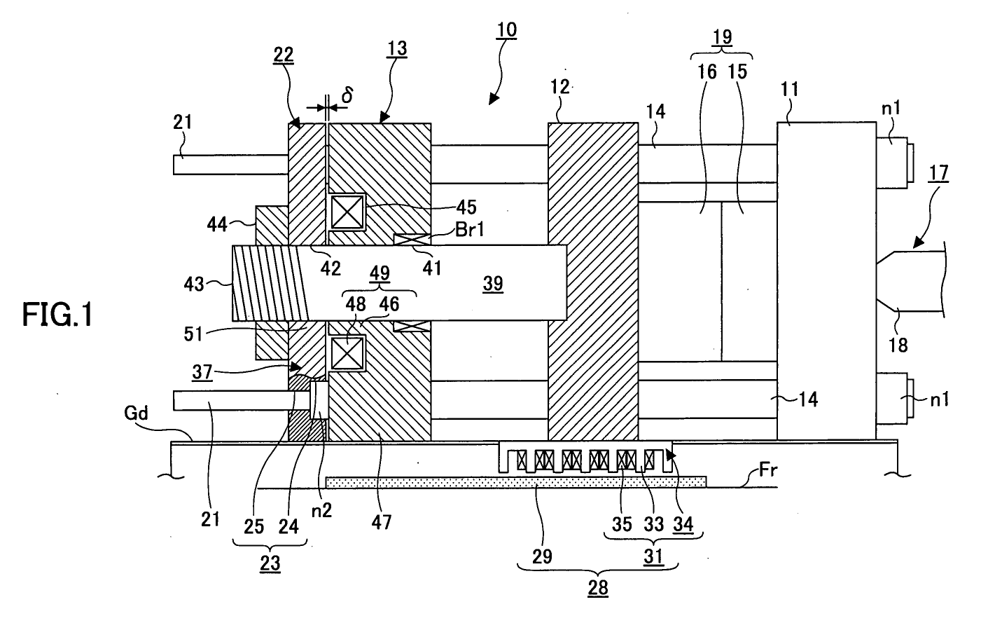

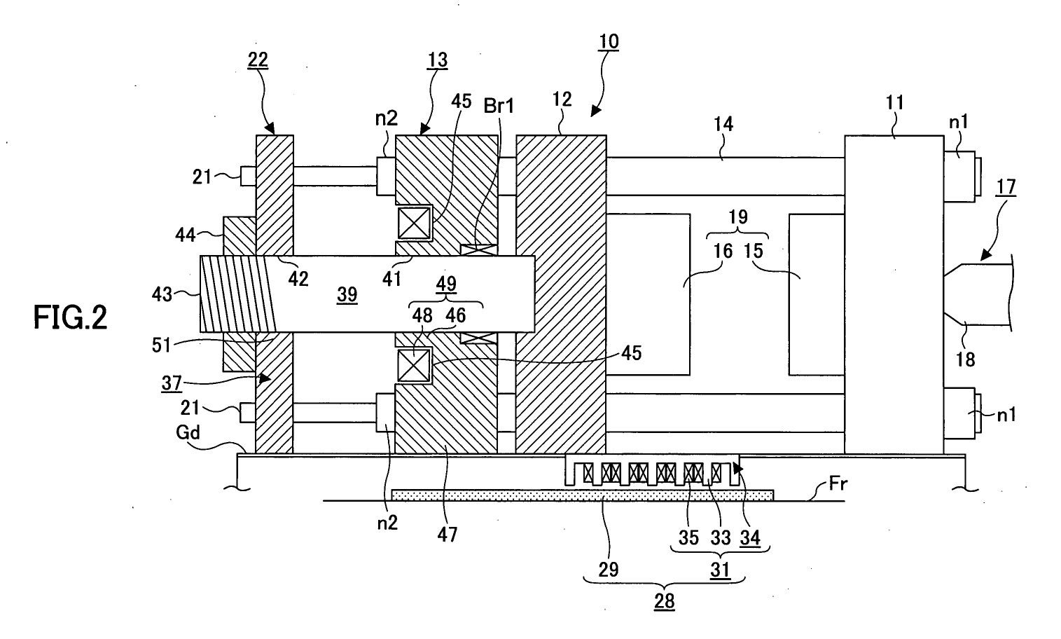

FIG. 1 shows the condition of a mold device and a mold clamping device in an embodiment of the invention at the time of mold closing. FIG. 2 shows the condition of the mold device and the mold clamping device in the embodiment of the invention at the time of mold opening.

In FIG. 1 and FIG. 2, reference numeral 10 denotes the mold clamping device, reference character Fr denotes the frame of an injection molding machine, and reference character Gd denotes two guides (first guide member) which constitute the rails disposed on the frame Fr, and support and guide the mold clamping device 10. In FIG. 1 and FIG. 2, only one of the two guides Gd is illustrated.

Reference numeral 11 denotes a fixed platen (first fixed member) which is placed on the guides Gd and fixed to the frame Fr and the guides Gd. Reference numeral 13 denotes a rear platen (second fixed member) which is separated from the fixed platen 11 with a predetermined spacing and arranged to confront the fixed platen 11. Reference numeral 14 denotes four tie bars (four connecting members) which are arranged between the fixed platen 11 and the rear platen 13. In FIG. 1 and FIG. 2, only two of the four tie bars 14 are illustrated. The rear platen 13 is placed on the guides Gd so that the position of the rear platen 13 relative to the guides Gd can be adjusted slightly when the tie bars 14 are expanded or contracted.

In this embodiment, the fixed platen 11 is fixed relative to the frame Fr and the guides Gd and the rear platen 13 can be slightly moved relative to the guides Gd. Alternatively, the mold clamping device may be arranged so that the rear platen 13 is fixed relative to the frame Fr and the guides Gd and the fixed platen 11 can be slightly moved relative to the guides Gd.

A movable platen 12 (first movable member) is arranged along the tie bars 14 to confront the fixed platen 11, so that the movable platen 12 is movable in each of mold opening/closing directions. For this reason, guide holes (not illustrated) are formed in the parts of the movable platen 12 corresponding to the tie bars 14, and the tie bars 14 pass through the guide holes respectively.

A first threaded part (not illustrated) is formed in the front end part of each tie bar 14, and the tie bars 14 are secured to the fixed platen 11 by fastening the first threaded parts with nuts n1 respectively. In a predetermined portion behind the rear end part of each tie bar 14, a guide post 21 (second guide member) is formed integrally with the tie bar 14, and each guide post has an outside diameter smaller than that of the tie bar 14 and projects rearward from the rear end face of the rear platen 13.

Moreover, second threaded parts (not illustrated) are formed in the vicinity of the rear end face of the rear platen 13, and the fixed platen 11 and the rear platen 13 are connected together by fastening the second threaded parts with nuts n2.

In this embodiment, the guide posts 21 are formed integrally with the tie bars 14. Alternatively, the tie bars 14 and the guide posts 21 may be formed as separate components.

A fixed mold 15 (first mold) is fixed to the fixed platen 11 and a movable mold 16 (second mold) is fixed to the movable platen 12, respectively. Connection/disconnection of the fixed mold 15 and the movable mold 16 is performed through the forward/rearward movement of the movable platen 12, so that one of mold closing, mold clamping, and mold opening is carried out.

When mold clamping is carried out, two or more cavity spaces (not illustrated) are formed between the fixed mold 15 and the movable mold 16, and the resin (not illustrated) which is injected from the discharge nozzle 18 of the injection apparatus 17 is filled in the respective cavity spaces. A mold device 19 is constituted by the fixed mold 15 and the movable mold 16.

A movable plate 22 (second movable member) is arranged in parallel with the movable platen 12, and this movable plate 22 is located at the rear of the rear platen 13 and is movable along the guide posts 21 in a forward/rearward direction while it is guided by the guide posts 21.

Guide holes 23 which the guide posts 21 pass through are formed in corresponding portions of the movable plate 22 for the respective guide posts 21. Each guide hole 23 includes a major-diameter part 24 and a minor-diameter part 25. The minor-diameter part 25 is made open to the rear end face of the movable plate 22 and includes sliding surfaces on which the guide post 21 slides. The major-diameter part 24 is made open to the front end surface of the movable plate 22 and accommodates the ball nut n2 therein. In this embodiment, the movable plate 22 is guided by the guide posts 21. Alternatively, the movable plate 22 may be guided by not only the guide posts 21 but also the guides Gd.

In order to move the movable platen 12 in the forward/rearward direction, a linear motor 28 (first actuator) which is an actuator for performing mold opening/closing is arranged between the movable platen 12 and the frame Fr. The linear motor 28 includes a stator 29 (first drive element) and movable parts 31 (second drive element). The stator 29 is arranged on the frame Fr in parallel with the guides Gd. The location of the stator 29 corresponds to the moving range of the movable platen 12. The movable parts 31 are attached to the bottom end face of the movable platen 12, and the movable parts 31 are arranged to face the stator 29 and they are located over a predetermined range.

Suppose that Lp denotes the length of the stator 29, Lm denotes the length of the movable parts 31, and Lst denotes the stroke of the movable platen 12. The length Lm of the movable parts 31 is predetermined in accordance with the maximum impelling force according to the linear motor 28. The length Lp of the stator 29 is predetermined so as to meet the condition: Lp>Lm+Lst.

The movable parts 31 include a core 34 and coils 35. The core 34 includes two or more magnetic pole teeth 33 which are formed in a predetermined pitch and project towards the stator 29, and each coil 35 is wound around each magnetic pole tooth 33. The magnetic pole teeth 33 are arranged in parallel with each other and in the direction perpendicular to the moving direction of the movable platen 12.

The stator 29 includes a core (not illustrated) and a permanent magnet which is formed to extend on the core. This permanent magnet is formed by magnetizing it with N poles and S poles which are arranged in the same pitch as the magnetic pole teeth 33. Therefore, when the linear motor 28 is driven by supplying a predetermined current to the coils 35, the movable parts 31 are moved so that the movable platen 12 can be moved accordingly to perform either of mold closing and mold opening.

In this embodiment, the permanent magnet is arranged in the stator 29 and the coils 35 are arranged in the movable parts 31. Alternatively, the coils may be arranged in the stator and the permanent magnet may be arranged in the movable parts. In such alternative case, the coils are not moved in association with the driving of the linear motor 28, and the wiring for supplying electric power to the coils can be made easily.

When the movable platen 12 is moved in the forward direction and the movable mold 16 contacts the fixed mold 15, mold closing is performed, and then mold clamping is performed. In order to perform mold clamping, an electromagnet unit 37 which is a second actuator and acts as an actuator for performing mold clamping is arranged between the rear platen 13 and the movable plate 22. And a rod 39 (clamping-force transfer member) is arranged movably and prolonged to penetrate the rear platen 13 and the movable plate 22 and connect the movable platen 12 and the movable plate 22. The rod 39 is interlocked with the movement of the movable platen 12 to move the movable plate 22 at a time of mold closing or mold opening, and transmit a clamping force, generated by the electromagnet unit 37 at a time of mold clamping, to the movable platen 12.

The mold clamping device 10 is constituted by the fixed platen 11, the movable platen 12, the rear platen 13, the movable plate 22, the linear motor 28, the electromagnet unit 37, and the rod 39.

The electromagnet unit 37 includes an electromagnet 49 (first actuator member) arranged in a side surface of the rear platen 13, and an attraction part 51 (second actuator member) arranged in the side surface of the movable plate 22. The attraction part 51 is formed in a predetermined part of the front end surface of the movable plate 22. The attraction part 51 in this embodiment is formed in the part of the front end surface of the movable plate 22 which surrounds the rod 39 and faces the electromagnet 49.

Moreover, in this embodiment, a coil placement part 45 which is a groove-like cavity is formed in a predetermined part of the rear end face of the rear platen 13, and this coil placement part 45 (the groove-like cavity) is located at a predetermined distance from the hole 41 through which the rod 39 penetrates the rear platen 13. A core 46 is arranged in the coil placement part 45 of the rear platen 13, and a yoke 47 is arranged in another part of the rear plate 13. A coil 48 is embedded in the coil placement part 45 and wound around the core 46.

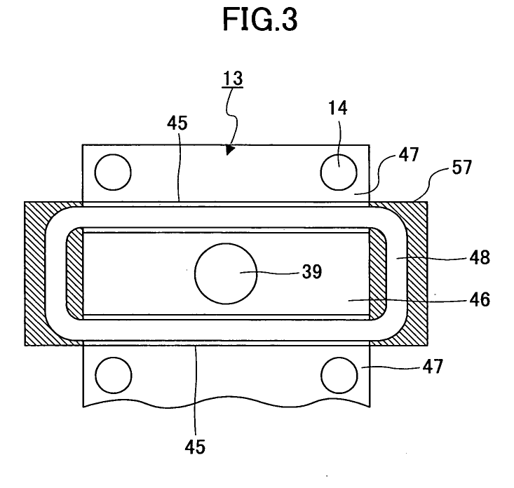

FIG. 3 shows the condition of a coil placement part in a first embodiment of the invention when resin molding is performed. As shown in FIG. 3, the coil placement part 45 is in the condition that the resin molding is performed and the resin is filled between the coil 48 and the core 46/the yoke 47. Accordingly, the heat generated in the coil 48 is transmitted to the core 46 and the yoke 47 through the mold part 57. Thus, the heat transfer characteristic of this embodiment is raised from that in the case in which the heat is merely radiated to the atmospheric air, and it is possible to supply an increased amount of current to the coil 48 and exert the clamping force on the mold device 19 for a longer time.

In the above-mentioned embodiment, the core 46 and the yoke 47 are formed using an integral mold of a casting. Alternatively, the core 46 and the yoke 47 may be formed from an electromagnetism laminated steel sheet in which a thin layer of a ferromagnetic material is laminated.

In the above-mentioned embodiment, the electromagnet 49 is formed to be separate from the rear platen 13 and the attraction part 51 is formed to be separate from the movable plate 22. Alternatively, the electromagnet may be formed integrally as a part of the rear platen 13, and the attraction part may be formed integrally as a part of the movable plate 22.

Therefore, in the above-mentioned embodiment, when current is supplied to the coil 48 in the electromagnet unit 37, the electromagnet 49 is driven and the attraction part 51 is attracted so that the clamping force can be generated.

The rod 39 is arranged so that the rear end part of the rod 39 is connected to the movable plate 22 and the front end part of the rod 39 is connected to the movable platen 12. Therefore, the rod 39 is moved in the forward direction in association with forward movement of the movable platen 12 at a time of mold closing, to move the movable plate 22 in the forward direction. On the other hand, the rod 39 is moved in the rearward direction in association with rearward movement of the movable platen 12 at a time of mold opening, to move the movable plate 22 in the rearward direction.

Therefore, the hole 41 which penetrates the rod 39 is formed in the center of the rear platen 13, and the hole 42 which penetrates the rod 39 is formed in the center of the movable plate 22. A bearing member Br1, such as a bushing, which supports the rod 39 slidably is arranged in the opening at the front end part of the hole 41. A screw thread 43 is formed at the rear end part of the rod 39, and the screw thread 43 and a nut 44 are fastened together. The nut 44 is arranged, as a mold thickness adjustment mechanism for adjusting the mold thickness, in a manner that the nut 44 is supported to be rotatable with respect to the movable plate 22.

When the mold closing is completed, the movable plate 22 is moved to approach the rear platen 13, and a gap δ is formed between the rear platen 13 and the movable plate 22. If the gap δ is too small or too large, the attraction part 51 cannot be attracted adequately, which causes the clamping force to be small. And the optimal gap δ varies depending on the change of the thickness of the mold device 19.

To obviate the problem, a gear with a large diameter (which is not illustrated) is arranged on the external peripheral surface of the nut 44, and a mold thickness adjusting motor (which is not illustrated) as an actuator for the mold thickness adjustment is arranged on the movable plate 22. A gear with a small diameter which is attached to the output shaft of the mold thickness adjusting motor and the gear which is arranged on the external peripheral surface of the nut 44 are engaged with each other.

If the mold thickness adjusting motor is driven in accordance with the thickness of the mold device 19 and the nut 44 is rotated by a given amount of rotational angle relative to the screw thread 43, the location of the rod 39 relative to the movable plate 22 is adjusted and the location of the movable plate 22 relative to the fixed platen 11 and the movable platen 12 is adjusted, so that the gap δ can be set to be the optimal value. That is, adjustment of the mold thickness is performed by changing the relative location of the movable platen 12 and the movable plate 22.

The mold thickness adjusting device is constituted by the mold thickness adjusting motor, the gear, the nut 44, and the rod 39. A rotation transmitting portion which transmits the rotation of the mold thickness adjusting motor to the nut 44 is constituted by the gear. A movement direction conversion unit is constituted by the nut 44 and the screw thread 43, and the rotary motion of the nut 44 is converted into the straight-line movement of the rod 39 by the movement direction conversion unit. In this case, a first conversion component is constituted by the nut 44 and a second conversion component is constituted by the screw thread 43.

Next, the operation of the mold clamping device 10 of the above-mentioned embodiment will be explained.

When a new mold device 19 is attached according to the exchange of the mold device 19, the distance between the movable plate 22 and the movable platen 12 is changed in accordance with the thickness of the new mold device 19, and the mold thickness adjustment is performed.

In this mold thickness adjustment, the fixed mold 15 and the movable mold 16 are attached to the fixed platen 11 and the movable platen 12, respectively, and the movable mold 16 is moved in the rearward direction, and the mold device 19 is arranged in an opened condition.

Then, in a distance adjusting process, the linear motor 28 is driven to bring the movable mold 16 into contact with the fixed mold 15 temporarily. Clamping force is not generated at this time.

In this condition, the mold thickness adjusting motor is driven to rotate the nut 44, so that the distance (i.e., the gap δ) between the rear platen 13 and the movable plate 22 is adjusted to be a predetermined value.

At this time, the coil 48 is embedded in the rear platen 13 in a manner that the coil 48 may not be damaged even if the rear platen 13 and the movable plate 22 are in contact and the coil 48 may not project from the surface of the rear platen 13. In this case, the surface of the rear platen 13 functions as a stopper for preventing damaging of the coil 48.

Then, the mold opening/closing processing unit of the control unit (which is not illustrated) performs mold opening/closing processing, and supplies the current to coil 35 in the condition of FIG. 2 at the time of mold closing.

Subsequently, the linear motor 28 is driven to move the movable platen 12 in the forward direction, and the movable mold 16 is brought into contact with the fixed mold 15 as shown in FIG. 1. At this time, the gap δ is formed between the rear platen 13 and the movable plate 22 (i.e., the gap between the electromagnet 49 and the attraction part 51). The force needed for performing mold closing is set to be sufficiently smaller than the clamping force.

Then, at the time of mold clamping, the mold opening/closing processing unit supplies the current to the coil 48, and the attraction part 51 is attracted by the attraction force of the electromagnet 49.

In association with this, the clamping force is transmitted to the movable platen 12 through the movable plate 22 and the rod 39, so that mold clamping is performed. When changing the clamping force in this embodiment at the beginning of mold clamping or the like, the control unit controls the mold clamping device 10 by supplying to the coil 48 the steady-state current (the value of which is called “rated current”) needed to generate a target clamping force in a steady state (i.e., the target clamping force acquired in accordance with the change of the previous clamping force, which is called “steady clamping force”).

In the coil placement part 45 of the above-mentioned embodiment, the mold part 57 which is filled with the resin is formed between the coil 48 and the core 46/the yoke 47. Thus, even when the current is continuously supplied to the coil 48 for a long time, the generated heat is transferred to the core 46 and the yoke 47 through the mold part 57. For this reason, it is possible to increase the rated current, and it is possible to apply the clamping force for a longer time.

In the above-mentioned embodiment, the clamping force is detected by using a load detecting device (which is not illustrated), and the detected clamping force is transmitted to the control unit. In the control unit, feedback control is performed with the received clamping force, and the current being supplied to the coil 48 is adjusted so that the clamping force is set to the predetermined value.

In the meantime, the resin which is made molten in the injection apparatus 17 is injected from the discharge nozzle 18, and the respective cavity spaces of the mold device 19 are filled with the resin.

A load cell arranged on the rod 39, or a sensor which measures the amount of elongation of the tie bars 14, etc. may be used as the load detecting device.

When the resin in each cavity space is cooled and solidified, the mold opening/closing processing unit stops supplying of the current to the coil 48 at the time of mold opening so that the mold clamping device 10 is in the condition of FIG. 1. In association with this, the linear motor 28 is driven to move the movable platen 12 in the rearward direction, and mold opening is performed so that the movable mold 16 is set in the rearward position as shown in FIG. 2.

In the above-mentioned embodiment, the core 46 and the yoke 47, and the entire movable plate 22 are formed from an electromagnetism laminated steel sheet. Alternatively, the circumference of the core 46 in the rear platen 13 and the attraction part 51 may be formed from an electromagnetism laminated steel plate.

In the above-mentioned embodiment, the electromagnet 49 is formed in the rear end face of the rear platen 13 and the attraction part 51 is arranged movably in the front end surface of the movable plate 22 to face the electromagnet 49. Alternatively, the attraction part may be arranged the rear end face of the rear platen 13, and the electromagnet may be arranged movably in the front end surface of the movable plate 22 to face the attraction part.

In the above-mentioned embodiment, the linear motor 28 is arranged as the first actuator. Alternatively, an electromotive motor, an oil hydraulic cylinder, etc. may be arranged instead of the linear motor 28. When the electromotive motor is used, the rotary motion generated by driving the motor is converted into a straight-line movement by the ball screw which is provided as the movement direction conversion unit, and the movable platen 12 is moved in the forward/rearward direction.

The mold clamping device 10 of the first embodiment is arranged so that the coil 48 projects to the outside of the rear platen 13. Thus, there is a problem in that in order to perform molding in the coil 48, it is necessary to perform a complicated operation. For example, the conceivable method is to perform molding in the coil by injecting the molding material (resin) into the molding jig when the whole coil 48 is fully accommodated in the molding jig is conceivable.

In this case, the jig in which the whole coil 48 is accommodated must be prepared, which causes the manufacturing cost to be increased. Moreover, an additional process in which the coil 48 after the molding was performed is removed from the jig concerned and the coil 48 is arranged in the rear platen 13 must be performed.

Moreover, when the coil molding is performed while the coil 48 is arranged in the rear platen 13, the jig for supplying the molding material must be installed in the mold clamping device 10. When the coil is arranged to partially project from the outside of the rear platen, a complicated operation must be performed to install the jig concerned.

Next, the second embodiment of the invention in which the problem of the first embodiment of the invention is eliminated will be explained.

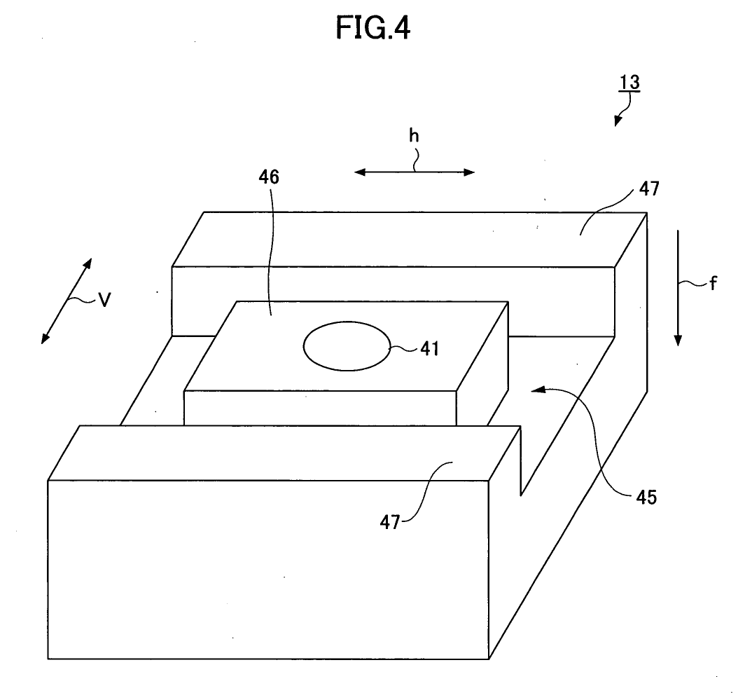

FIG. 4 is a perspective view of a rear platen in the second embodiment of the invention for explaining the configuration. In FIG. 4, the elements which are essentially the same as corresponding elements in FIG. 1 or FIG. 2 are designated by the same reference numerals, and a description thereof will be omitted.

In FIG. 4, the arrow h and the arrow v indicate the right-and-left direction (horizontal direction) of the rear platen 13, and the up-and-down direction (vertical direction) of the rear platen 13, respectively. However, this notation is given for the sake of convenience of description. Alternatively, the arrow h may indicate the up-and-down direction and the arrow v may indicate the right-and-left direction. In FIG. 4, the arrow f indicates the front-end direction of the rear platen 13.

As shown in FIG. 4, in the second embodiment, a coil placement part 45 which is an annular groove-like cavity is formed in a predetermined part of the rear end face of the rear platen 13, and the annular coil placement part 45 is located at a predetermined distance from the hole 41 through which the rod 39 penetrates the rear platen 13. A core 46 is arranged at a projecting part inside the coil placement part 45, and a yoke 47 is arranged at projecting parts outside the coil placement part 45.

The width of the coil placement part 45 is suitably set to the dimension by which the coil 48 is wound around the core 46 adequately. The coil 48 is heated when current flows through the coil 48, and the coil 48 is contracted by the thermal expansion. For this reason, it is preferred that the width of the coil placement part 45 is set to an adequately large dimension which does not cause friction against the yoke 47 due to the contraction of the coil 48.

The depth of the coil placement part 45 is set to a dimension such that the coil 48 does not project from the rear end face of the rear platen 13. Since the whole end-face surface of the coil 48 does not project from the rear end face of the rear platen 13, even if the movable plate 22 and the rear platen 13 are in contact due to abnormalities, it is possible to prevent damaging of the coil 48.

In this manner, the coil 48 is arranged so that it is accommodated in the coil placement part 45 and the coil 48 does not project from the rear platen 13. It is possible to perform the operation for molding to the coil 48 easily. When performing the molding in the coil 48, pouring a molding material, such as resin, into the coil placement part 45 is possible in the condition in which the coil 48 is arranged in the coil placement part 45.

However, the circumference of the coil placement part 45 is not fully surrounded by the side walls. Namely, in the second embodiment, the yoke 47 used as the outside walls of the coil placement part 45 is formed only in the upper and lower sides of the rectangle which forms the coil placement part 45. The right and left sides of the rectangle which forms the coil placement part 45 are open to the side faces of the rear platen 13.

Therefore, rectangular auxiliary members may be arranged at the “opening parts” of the coil placement part 45 where the side faces of the rear platen 13 are opened. This allows the circumference of the coil placement part 45 to be fully surrounded by the side faces of the rear platen 13 and the auxiliary members, when pouring the molding material into the coil placement part 45.

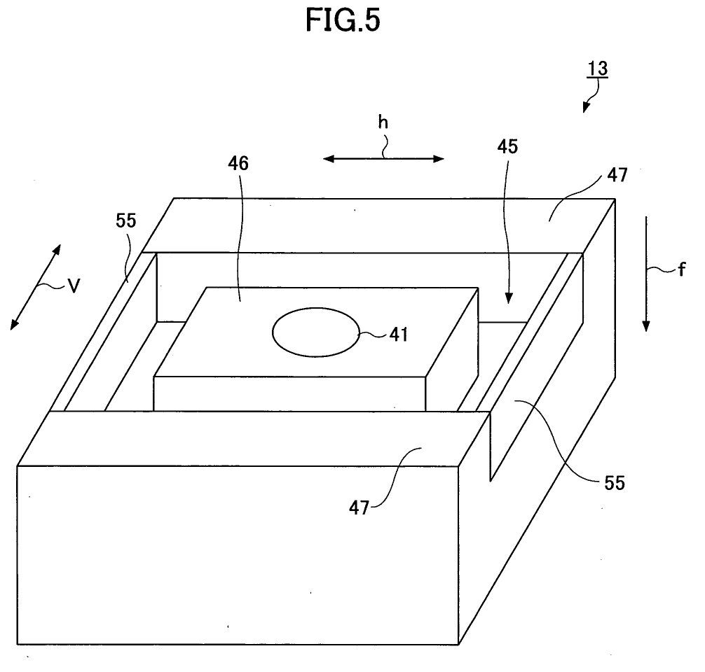

FIG. 5 is a perspective view of a rear platen in which auxiliary members are arranged at opening parts of a coil placement part for explaining the configuration.

By arranging the auxiliary members 55, as shown in FIG. 5, at the opening parts of the coil placement part 45 in the rear platen 13, the opening parts of the coil placement part 45 can be closed. Therefore, if the molding material is poured into the coil placement part 45 in the condition in which the auxiliary members 55 are arranged, it is possible to prevent the outflow of the molding material. For the sake of convenience of illustration, the indication of the coil 48 is omitted in FIG. 5.

After the molding material is poured into the coil placement part 45 in the condition of FIG. 5, the coil 48 is embedded in the rear platen 13 and fixed thereto by the molding material when the molding material is solidified.

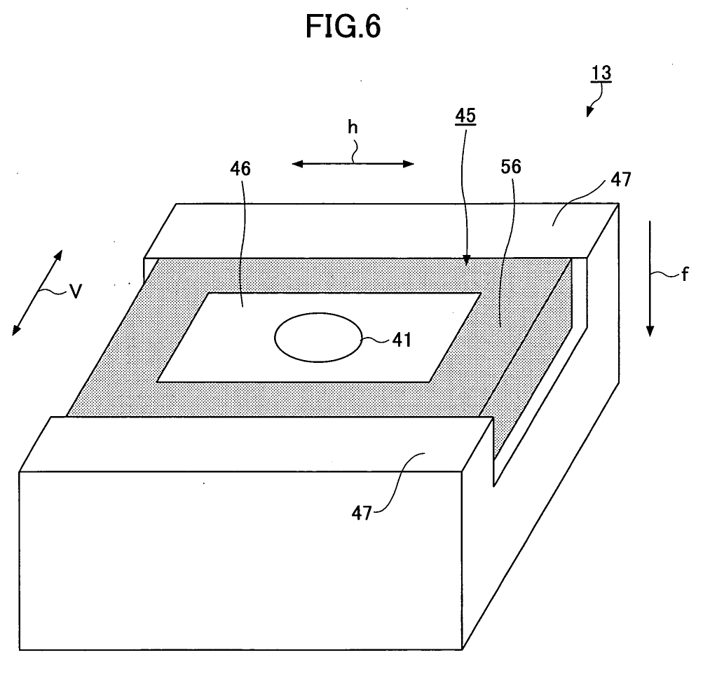

FIG. 6 is a perspective view of a rear platen in which a coil is embedded in the rear platen by a molding material. In the example of FIG. 6, after the molding material 56 is solidified, the auxiliary members 55 are removed. Alternatively, the auxiliary members 55 may be left as the components which constitute a part of the rear platen 13 without being removed. In this case, in order to decrease the influence by the magnetism, it is preferred that the auxiliary members 55 are made of a nonmagnetic material.

It is necessary to form the molding material 56 so that the projection from the rear platen 13 may not be detrimental when securing the gap δ and the movable plate 22 may be damaged. From this viewpoint, it is preferred that the molding material 56 is fully enclosed in the coil placement part 45 so as not to project from the rear end face of the rear platen 13.

As mentioned above, in the mold clamping device 10 of the second embodiment, the coil placement part 45 is formed in the rear platen 13, so that the coil 48 may not project from the upper and lower side faces and the right and left side faces of the rear platen 13. Therefore, the rear platen 13 functions as a jig when pouring the molding material, and the molding in the coil 48 can be performed by arranging the auxiliary members 55.

The molding to the coil 48 is performed and the contact surface area of the coil 48 and the rear platen 13 can be increased by the molding material 56. This allow the heat generated in the coil 48 to be transmitted to the rear platen 13 efficiently. The heat of the coil 48 is easily be transmitted to the atmospheric air through the molding material. Therefore, the cooling effect of the coil 48 can be raised and damaging of the coil 48 can be prevented. Moreover, the coil does not project from the pole, and the leakage flux can be reduced and the influences on the peripheral devices by the leakage flux can be reduced.

Next, the third embodiment of the invention will be explained.

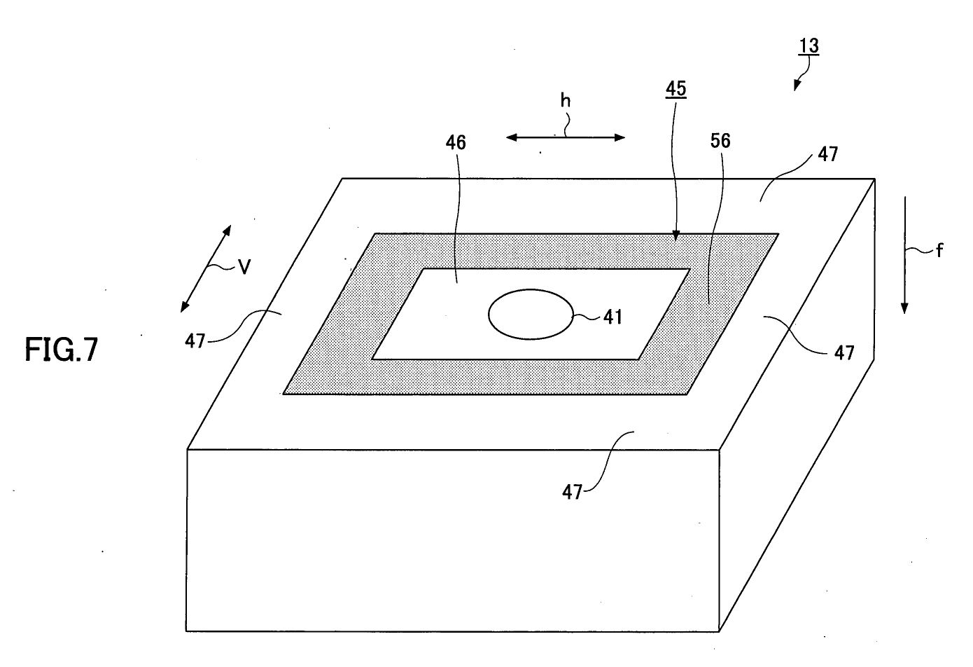

FIG. 7 is a perspective view of a rear platen in the third embodiment of the invention in which the coil is embedded in the rear platen by a molding material. In FIG. 7, the elements which are essentially the same as corresponding elements in FIG. 6 are designated by the same reference numerals, and a description thereof will be omitted unless otherwise specified.

What is different from the second embodiment in the third embodiment is that the coil placement part 45 is formed so that the circumference of the coil placement part 45 is fully surrounded by the yoke 47.

That is, the coil placement part 45 in the third embodiment has no opening part for all of the side faces of the rear platen 13, and it is fully surrounded by the yoke 47. Therefore, the molding material can be poured without using the auxiliary members, and the operation for performing molding in the coil 48 can be performed more easily.

When generating clamping force using the electromagnet as in this embodiment, the attraction force is generated in the coil 48 by the magnetism directed to the movable plate 22. For this reason, it is necessary to firmly retain the coil 48 and the molding material 56 in the rear platen 13. The cross-sectional configuration of the coil placement part 45 is modified as in the above-mentioned embodiment, and, even when the electromagnetic force acts on the coil, the molding material in which the coil is embedded can receive the attraction force produced by the electromagnetic force through the internal side walls of the groove 45. As a result, the molding material 56 can be secured to the rear platen 13 firmly.

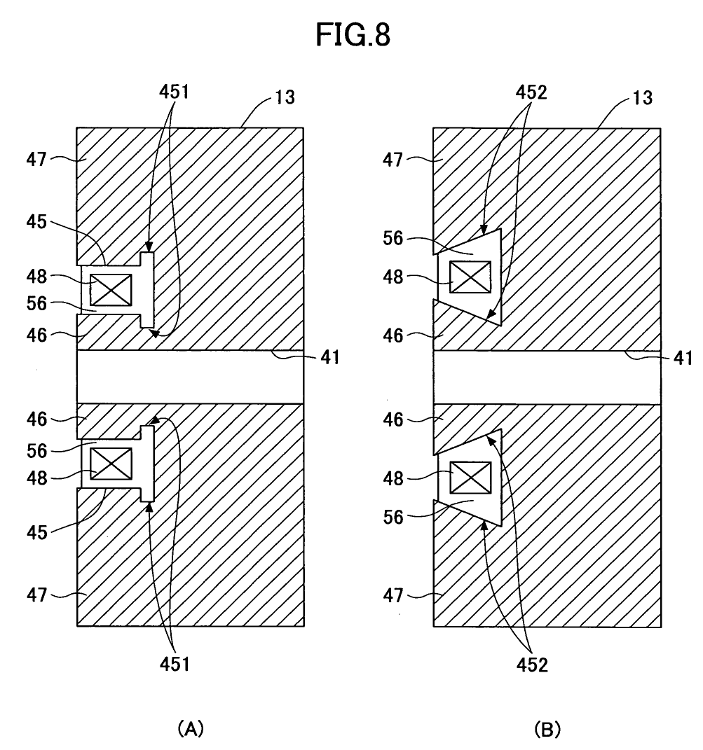

FIG. 8A and FIG. 8B are diagrams showing the configurations of rear platens for explaining the cross-sectional configurations of each coil placement part. The diagrams of FIG. 8A and FIG. 8B show the cross-sections of the rear platens which are the same as that of the rear platen 13 in FIG. 1 or FIG. 2.

FIG. 8A shows the example in which a groove 451 is formed in the coil placement part 45. That is, the groove 451 is formed along the coil placement part 45, and the molding material 56 is poured into the groove 451 as well. Therefore, the molding material 56 can be fixed to the rear platen 13 more firmly.

FIG. 8B shows the example in which the side face perpendicular to the depth direction of the coil placement part 45 has a slope 452 so that the width of the coil placement part 45 gradually increases in the depth direction (the forward direction of the mold clamping device 10) of the coil placement part 45. Thus, the molding material 56 can be fixed to the rear platen 13 more firmly by the use of the slope 452.

Alternatively, the coil placement part 45 may be formed so that the width of the coil placement part 45 has a larger part than the width in the rear end face of the rear platen 13 in the depth direction. And the invention is not limited to the configurations as shown in FIG. 8A and FIG. 8B.

In this manner, the cross-section configuration of the coil placement part 45 is revised to the predetermined configuration, and even when the electromagnetic force acts on the coil, the molding material in which the coil is embedded can receive the attraction force produced by the electromagnetic force, by using the internal side walls of the groove 451. As a result, even if no special component part for attaching the coil 48 is provided, the coil 48 can be secured to the rear platen 13 firmly so as to withstand the attraction force.

In order to facilitate the forming of the cross-sectional configurations shown in FIG. 8A and FIG. 8B, it is preferred to use the configuration in which the side faces of the rear platen 13 are open at the opening parts of the coil placement part 45 as in the second embodiment.

The present invention is not limited to the above-described embodiments, and variations and modifications may be made without departing from the scope of the present invention.

The present international application is based on and claims the benefit of priority of Japanese patent application No. 2006-301592, filed on Nov. 7, 2006, the contents of which are incorporated by reference in their entirety.

We claim:

1. A mold clamping device which uses an electromagnet to generate clamping force, comprising:
a coil holding member holding a coil which constitutes a part of the electromagnet; and
a coil placement part arranged in a surface of the coil holding member to place the coil therein, wherein the coil is embedded in the coil placement part by a molding material.

2. The mold clamping device according to claim 1, wherein the molding material is placed under and does not project from the surface of the coil holding member.

3. The mold clamping device according to claim 1, wherein the coil placement part is arranged so that at least one of side faces of the coil holding member perpendicular to the surface of the coil holding member is opened.

4. The mold clamping device according to claim 1, wherein the coil placement part is arranged so that all of side faces of the coil holding member perpendicular to the surface of the coil holding member are closed.

5. The mold clamping device according to claim 1, wherein the coil placement part is arranged so that the coil placement part has a top-end portion on the surface of the coil holding member and a bottom-end portion in a depth direction of the coil placement part and a width of the bottom-end portion is larger than a width of the top-end portion.

6. The mold clamping device according to claim 5, wherein the coil placement part includes grooves on internal side faces perpendicular to the depth direction of the coil placement part.

7. The mold clamping device according to claim 5, wherein internal side faces perpendicular to the depth direction of the coil placement part are tapered so that a width of the coil placement part gradually increases in the depth direction.
